(19) United States
(12) Patent Application Publication
(10) Pub. No.: US 2006/0292684 A1
(43) Pub. Date: Dec. 28, 2006

(54) Method and system for treating oxidized contaminant-containing matrix

(76) Inventors: Harold W. Bentley, Tucson, AZ (US); Richard Bentley, Tucson, AZ (US)

Correspondence Address: LAWRENCE R. OREMLAND, P.C., 5055 E. BROADWAY BLVD., SUITE C-214, TUCSON, AZ, 85711, US

(21) Appl. No.: 11/449,395

(22) Filed: Jun. 8, 2006

Related U.S. Application Data
(60) Provisional application No. 60/688,474, filed on Jun. 8, 2005.

(51) Int. Cl. C02F 3/34

(52) U.S. Cl. 435/262

(57) ABSTRACT

A new and useful way of treating oxidized-contaminant-containing water, soil, rock, other geological or non-geological matrix formation (such as a landfill) is provided. A bioreactor is provided that includes elemental sulfur and a microbial population capable of oxidizing sulfur and reducing pertechnate (TcO₄⁻), arsenate (H₂AsO₄⁻), chromate (CrO₄²⁻), bromate (BrO₃⁻), chlorite (ClO₂⁻), chlorate (ClO₃⁻), perchlorate (ClO₄⁻), and uranium(VI) oxide, with biological reduction of these oxidized contaminants in the matrix containing the oxidized contaminant performed by the bioreactor, with the elemental sulfur as the electron donor.

### RELATED APPLICATIONS /CLAIM OF PRIORITY

This application is related to and claims priority from provisional application Ser. No. 60/688,474, filed Jun. 8, 2005, which provisional application is incorporated by reference herein.

### TECHNICAL FIELD

The present invention relates to a water, soil, other geologic or man-made formations (hereafter designated “matrix” as a group term covering all such substances and formations) treatment process and system that is capable of biologically reducing an oxidized contaminant with the aid of microbes.

### BACKGROUND OF THE INVENTION

Water treatment systems that biologically reduce perchlorate or other oxidized and mobile contaminants in water typically do so by passing the contaminant-bearing water through a bioreactor while supplementing the water with either organic carbon sources, such as acetate or ethanol, or with hydrogen. These supplementary compounds serve as electron donors to allow the microbial population to produce or maintain anaerobic and reducing conditions and reduce the oxidized contaminant to benign aqueous compounds or ions, or precipitate the reduced contaminant in the form of an insoluble solid which can then be removed or allowed to remain in place as an immobilized product. In the case of perchlorate, reduction to chloride or other chlorine species that are less oxidized than perchlorate is the end result.

However, bioreactor systems that use organic carbon sources produce residual organic byproducts that can be carried into the bioreactor's discharge stream or into the atmosphere. Such bioreactors also can generate excessive sludge, which leads to both fouling of the bioreactor and higher maintenance requirements for sludge removal from the treatment discharge. Bioreactors that utilize hydrogen must contend with hydrogen's hazardous explosive potential, require extensive apparatus in the form of tubing and controls, and are difficult to scale up to large volume systems. Bioreactors utilizing hydrogen as an electron donor also can produce acetate and other organic byproducts that potentially can contaminate the reactor discharge stream. Further, such bioreactor systems operate needing continuous addition of organic substrate or hydrogen, imposing added maintenance demands on the operator.

### SUMMARY OF THE INVENTION

In view of such problems of the prior art, a primary object of the present invention is to provide a matrix treatment process that reduces an oxidized contaminant such as perchlorate without generating excessive sludge, introducing significant concentrations of organic compounds into the treated matrix, or requiring the handling of hazardous components, and that is capable of biological oxidized contaminant reduction with a simplified, reduced maintenance apparatus.

A second object of the present invention is to provide an oxidized contaminant reduction process for the matrix that is capable of treating the matrix to a high degree of contaminant removal or immobilization with a minimum amount of time and at low cost.

A third object of the present invention is to provide a process to treat any matrix containing oxidized contaminant.

According to the present invention, such objects are accomplished by a process and system comprising: a matrix composed of or containing oxidized contaminant; a bioreactor, which may be ex-situ or in-situ, that accepts or contains the matrix; a source of elemental sulfur to allow for oxidized contaminant reduction within the bioreactor by sulfur-oxidizing microbes; a consortium of sulfur-oxidizing, oxidized contaminant-reducing chemolithotrophic microbes which either occur naturally in the oxidized contaminant-bearing matrix or are introduced to the bioreactor by inoculation. In some versions of the invention, the elemental sulfur utilized by the sulfur-oxidizing bacteria does not need to be added on a continuous basis, but rather can be added in large quantities periodically, thereby reducing maintenance requirements, and ultimately resulting in lower cost.

Preferably, the bioreactor also includes (or is provided with) nutrients needed for growth by the microbes including inorganic nitrogen and phosphorus compounds, inorganic carbon (bicarbonate and carbonate), and inorganic and organic trace nutrients that are supplied by support material in the bioreactor, by the oxidized contaminant-bearing matrix, or by addition to the matrix or the bioreactor. The consortium of microbes oxidizes the elemental sulfur (oxidation state 0) predominantly to sulfate (oxidation state +6); attains or maintains anaerobic conditions by reduction of other electron acceptors such as oxygen and nitrate; and reduces the oxidized contaminant, for example, perchlorate (chlorine oxidation state +7) predominantly to chloride (oxidation state −1); or in the case of another oxidized contaminant species, another benign ion or compound or immobilized component in the form of an insoluble precipitate which may be removed or allowed to remain in its immobilized state within the matrix. The extent of perchlorate or other oxidized contaminant removal or immobilization depends on the rate of reaction and the residence time in the bioreactor. The bioreactor is preferably designed to provide sufficient residence time to remove or immobilize the oxidized contaminant in a matrix to acceptable, typically health-based, concentration levels.

Other features of the present invention will become further apparent from the following detailed description and the accompanying drawings. Perchlorate will be used as an example of an oxidized contaminant treated by the process of the present invention.

### BRIEF DESCRIPTION OF THE FIGURES

FIGS. 1A through 3C show the results of shaken batch bioassay experiments conducted using 160-ml, capped glass serum flasks, containing 50 ml of liquid mineral medium composed of 5.2 mM Ammonium Hydrogen Carbonate (NH₄HCO₃), 1.4 mM Potassium Phosphate (K2HPO4), 0.4 mM Magnesium Sulfate (MgSO₄.7H₂O), 5.3 mM Sodium Bicarbonate (NaHCO₃), 0.07 mM Calcium Hydroxide (Ca(OH)₂), 0.02 mL trace element solution, 3 mM ClO4⁻ as electron acceptor, and 0.001 g of yeast extract, having 1.0 mM total CO₂ as carbon source, purged of oxygen by a 20% CO₂⁻80% N₂ gas mixture and using a five-fold stochiometric excess of H₂, S⁰ (elemental sulfur), or H₂S (as HS⁻) as possible electron donors. H₂S in aqueous solution exists almost completely as the bisulfide anion at the pH of the bioassay using hydrogen sulfide. The following microbial cultures were used in the bioassays as inoculums added to flasks during the course of the experiments: Nedalco anaerobic sludge, The Netherlands (Nedalco), returned activated sludge (RAS) from the aerobic sludge reactor at the Ina Road Wastewater Treatment Plant, Tucson, Ariz. (Ina Aerobic), and Ina Road Wastewater Treatment Plant anaerobic digestor sludge (Ina Anaerobic).

FIG. 1A compares the time course of perchlorate reduction in flasks containing no added electron donor and inoculated by the three inoculums obtained from aerobic and anaerobic environments;

FIG. 1B compares the time course of perchlorate reduction in flasks containing no inoculum with added electron donors none, hydrogen, H₂S (as HS⁻), or powdered elemental sulfur (S⁰).

FIG. 2 compares the time course of perchlorate reduction with powdered elemental sulfur (S⁰) using inoculums none, Ina Road anaerobic sludge, Ina Road aerobic RAS sludge, or Nedalco anaerobic sludge.

FIG. 3A compares the time course of perchlorate reduction in flasks using the Ina Aerobic inoculum and the electron donors H₂, powdered elemental sulfur (S⁰), or H₂S (as HS⁻).

FIG. 3B compares the time course of perchlorate reduction observed in flasks using inoculum obtained from Ina Anaerobic and the electron donors H₂, powdered elemental sulfur (S⁰), or H₂S (as HS⁻)

FIG. 3C compares the time course of perchlorate reduction observed in flasks using inoculum obtained from Nedalco and the electron donors H₂, powdered elemental sulfur (S⁰), or H₂S (as HS⁻)

FIG. 4 shows the results of shaken batch bioassay experiments performed in triplicate and conducted using 2.5 ml Ina Road aerobic RAS sludge as inoculum, with anaerobic conditions created by flushing with 20% CO₂⁻80% N₂ gas, the same mineral medium as before, including 3.0 mM ClO₄⁻as electron acceptor, and different forms of elemental sulfur as electron donors, including fine (⅛-inch) and coarse “popcorn” sulfur (popcorn sulfur is a form of elemental sulfur obtained as a sour-gas byproduct of the petroleum industry), flake sulfur, pastille sulfur (a lentil-shaped, low dust, high-purity particulate sulfur employed for acidification and other industrial purposes), and powdered sulfur. However, rather than the five-fold excess for electron donors, a larger excess of sulfur types were used: 19g/L each of ⅛-inch and coarse “popcorn” sulfur, flake sulfur, pastille sulfur, and 7.6 g/L powdered sulfur.

FIG. 5A compares the time course of chloride production observed in flasks using the bioassay conditions listed in the description of FIG. 4, and the following combinations of inocula (Ina Aerobic) and electron donor: inocula with pastille sulfur (S⁰), five-fold excess; no inocula, no e-donor; no inocula, pastille sulfur (S⁰); inocula, no e-donor.

FIG. 5B compares the time course of sulfate production observed in flasks using the bioassay conditions listed in the description of FIG. 4, and the following combinations of inocula (Ina Aerobic) and electron donor: inocula with pastille sulfur (S⁰), five-fold excess; no inocula, no e-donor; no inocula, pastille sulfur (S⁰); inocula, no e-donor.

FIG. 5C compares the time course of perchlorate removal observed in flasks using the bioassay conditions listed in the description of FIG. 4, and the following combinations of inocula (Ina Aerobic) and electron donor: inocula with pastille sulfur (S⁰), five-fold excess; no inocula, no e-donor; no inocula, pastille sulfur (S⁰); inocula, no e-donor.

FIGS. 6A-8C show the results of shaken batch bioassay experiments performed as described for FIGS. 1A-5C, but using as inocula either 2.5 mL of Ina Aerobic, 2.5 mL an enrichment culture obtained after a third transfer from a culture of elemental sulfur and Ina Aerobic inoculum, or no inocula. These figures compare results obtained with no electron donor; sulfide (as aqueous Na₂S), thiosulfate (as Na₂S₂O₃), or elemental (pastille) sulfur (S⁰).

FIG. 6A shows the time course of chloride evolution with no inoculum.

FIG. 6B shows the time course of chloride evolution with Ina Aerobic inoculum.

FIG. 6C shows the time course of chloride evolution with Ina Aerobic inoculum enriched 3×.

FIG. 7A shows the time course of sulfate evolution with no inoculum.

FIG. 7B shows the time course of sulfate evolution with Ina Aerobic inoculum.

FIG. 7C shows the time course of sulfate evolution with Ina Aerobic inoculum enriched 3×

FIG. 8A shows the time course of perchlorate evolution with no inoculum.

FIG. 8B shows the time course of perchlorate evolution with Ina Aerobic inoculum.

FIG. 8C shows the time course of perchlorate evolution with Ina Aerobic inoculum enriched 3×

FIG. 9A is a perchlorate reduction plot to estimate the zero-order maximum rate constant using 100 mL of mineral medium as previously but with the concentration change of sodium bicarbonate increased to 36 mM and the trace element composition changed. Five mL of fifth-enrichment inoculum (Ina Aerobic) was added instead of 2.5 mL; 20 mM of elemental sulfur and 3 mM of perchlorate.

FIG. 9B is a linear portion of the plot for FIG. 9A midway through the experiment that was assumed to be the zero-order region.

FIG. 10 is a schematic diagram of an exemplary system for practicing the principles of the present invention.

### DETAILED DISCUSSION

As described above, a primary object of the present invention is to provide a matrix treatment process and system that reduces an oxidized contaminant such as perchlorate. The principles of the present invention are described in detail below in connection with a process and a bioreactor for reducing perchlorate containing water, and from that description the manner in which the principles of the present invention can be used to reduce other oxidized contaminants in a matrix will be apparent to those in the art.

In a process according to the present invention, the reduction of perchlorate takes place in a bioreactor in the following way: perchlorate contained in a matrix within the bioreactor is reduced to chloride, and elemental sulfur is oxidized to sulfate by a consortium of sulfur-oxidizing, perchlorate-reducing microbes.

At steady-state, the overall, balanced chemical reaction for reduction of perchlorate is given by Equation (1):
4S⁰+3ClO₄⁻+4H₂O=3Cl⁻+4SO₄²⁻+8H⁺ (1)
where S⁰ is elemental sulfur, ClO₄⁻ is perchlorate ion, H₂O is water, Cl⁻ is chloride ion, SO₄²⁻ is sulfate ion and H⁺ is hydrogen ion. For each mg of ClO₄⁻ reduced completely to Cl⁻, this reaction contributes 1.29 mg SO₄²⁻ and 0.36 mg Cl⁻, and consumes 1.34 mg of total alkalinity as calcium carbonate alk(CaCO₃)

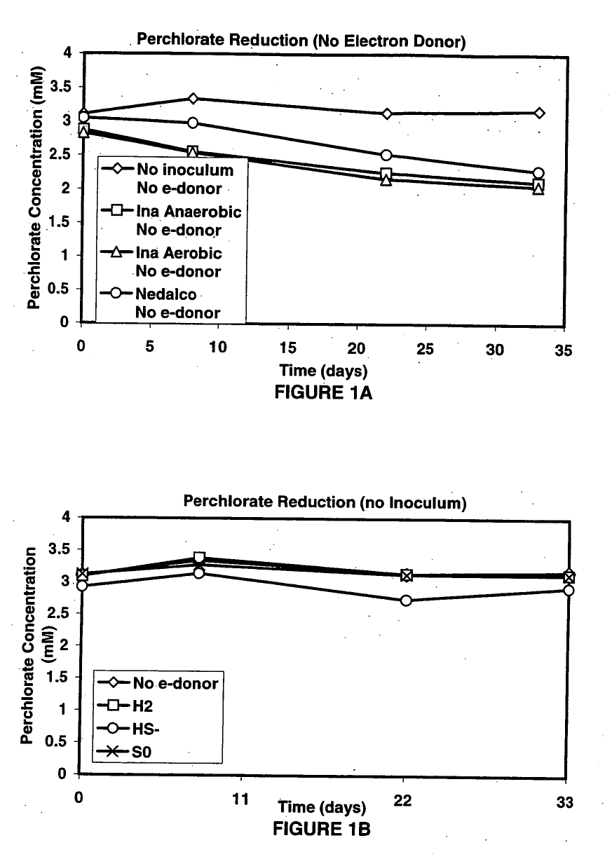

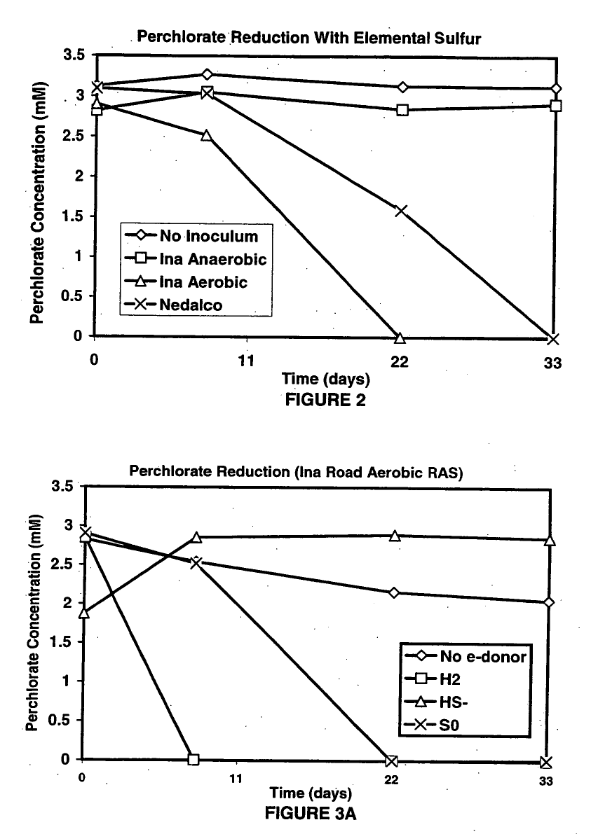

Based on this stochiometry as a guide to electron donor concentration, laboratory studies were made with various naturally occurring microbial consortiums used as inocula. FIG. 1A shows that with no added electron donor, perchlorate reduction is negligible with any of the three cultures used. FIG. 1B demonstrates that without inocula, various electron donors added to a perchlorate medium do not cause perchlorate reduction as well. FIG. 2, on the other hand, shows that two of the three inocula used reduce perchlorate if elemental sulfur is added to the medium as an electron donor.

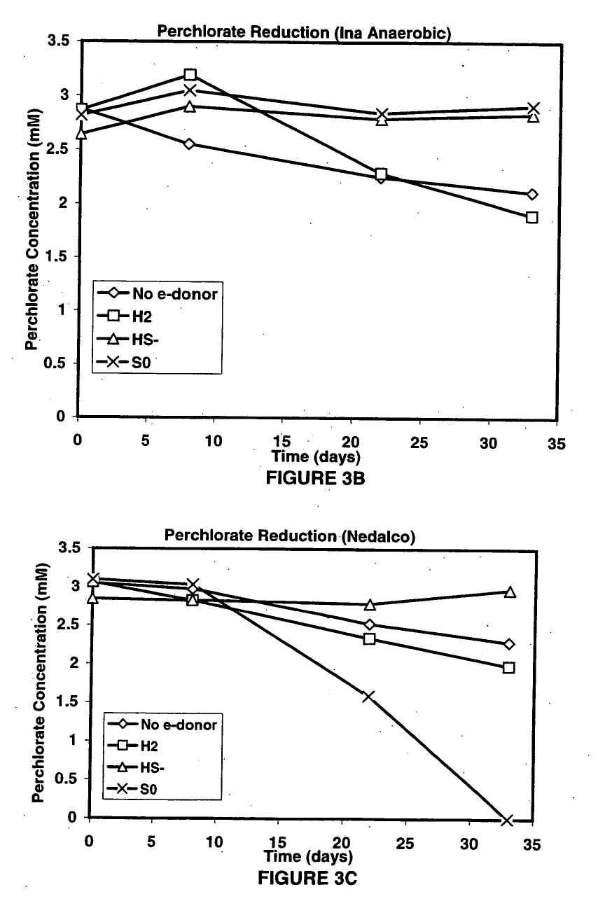

FIGS. 3A-3c are the result of preliminary screening of sulfur electron donors compared with hydrogen using all three inocula. From these experiments it was concluded that chemolithotrophic microbes can utilize elemental sulfur as an electron donor to reduce perchlorate.

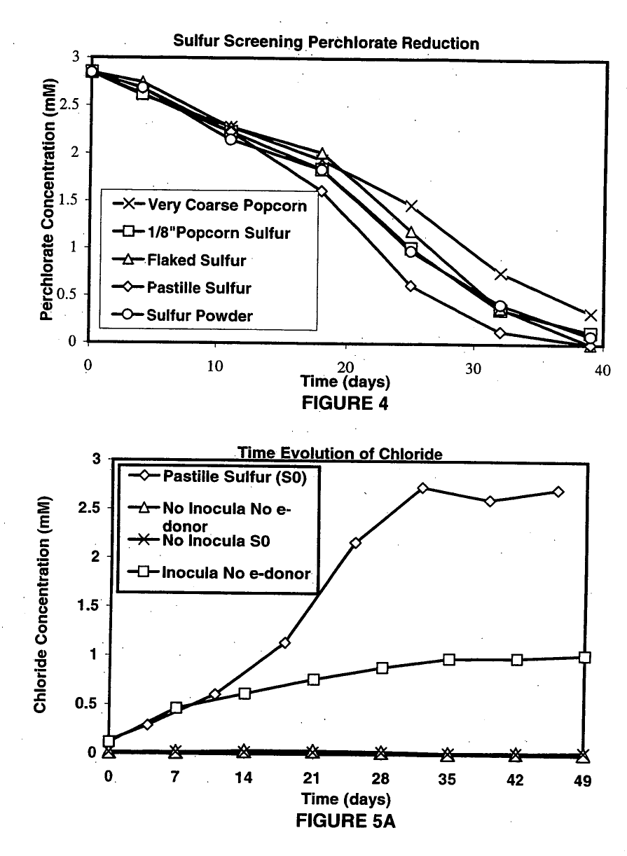

In order to determine the most effective form of elemental sulfur, screening experiments were undertaken using Ina Aerobic inoculum (the best performing inoculum) and various sulfur types for perchlorate reduction. The results are shown in FIG. 4, and indicate that pastille sulfur was the preferred type of the forms tested.

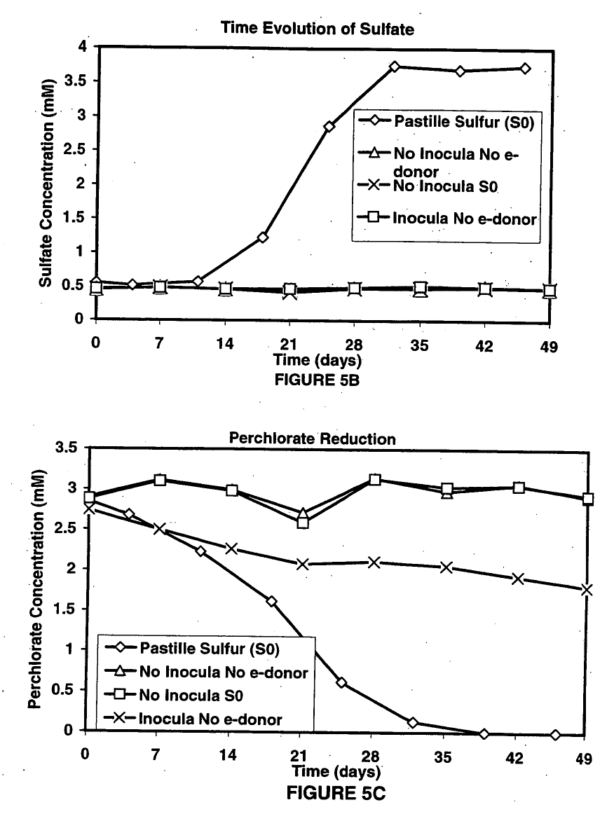

Once the preferred inoculum and sulfur form were determined, further batch bioassays were undertaken to measure time evolution of chloride, sulfate, and perchlorate reduction (FIGS. 5A-5C).

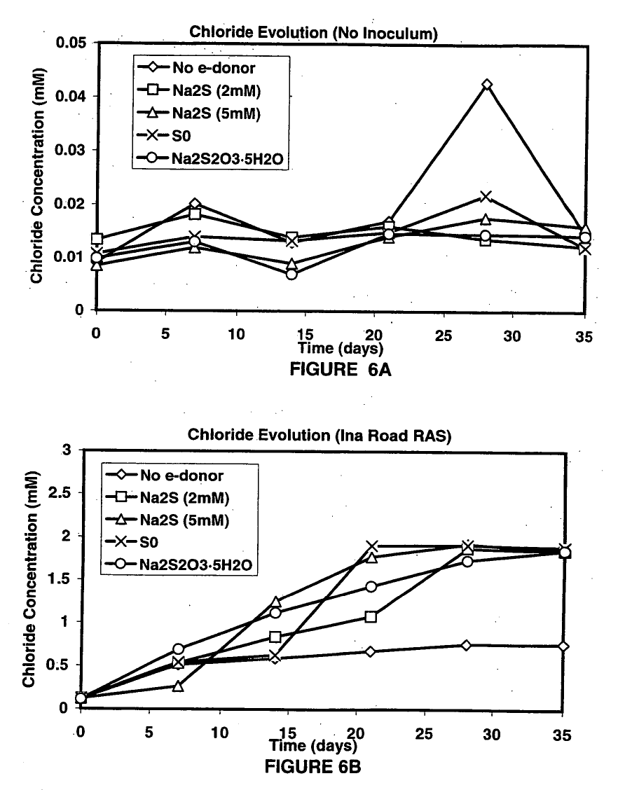

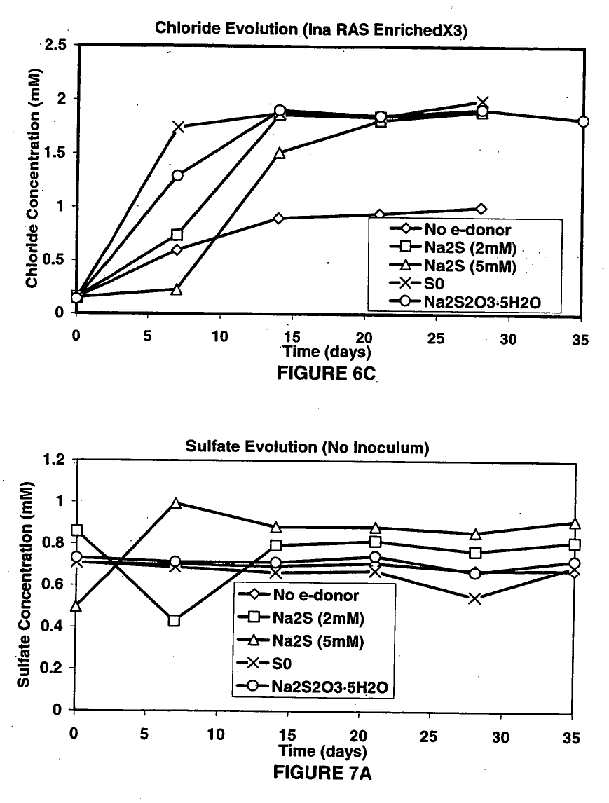

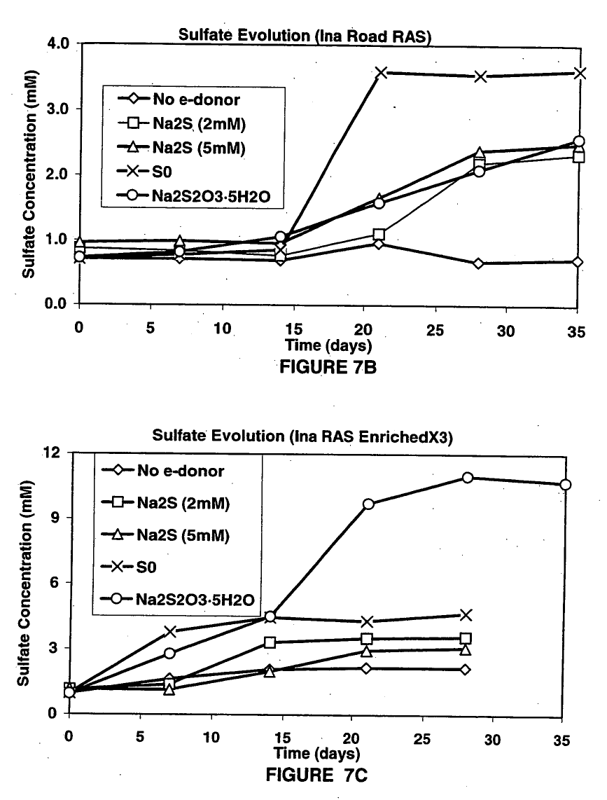

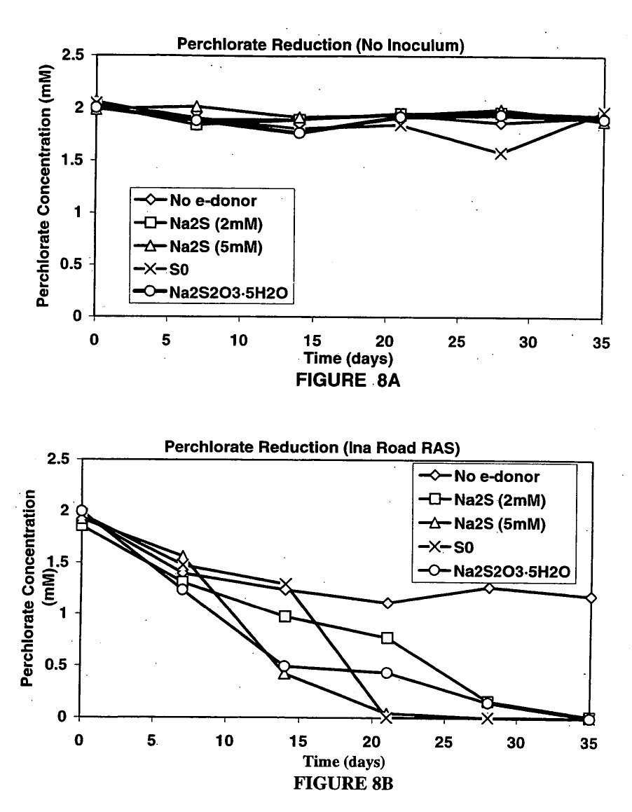

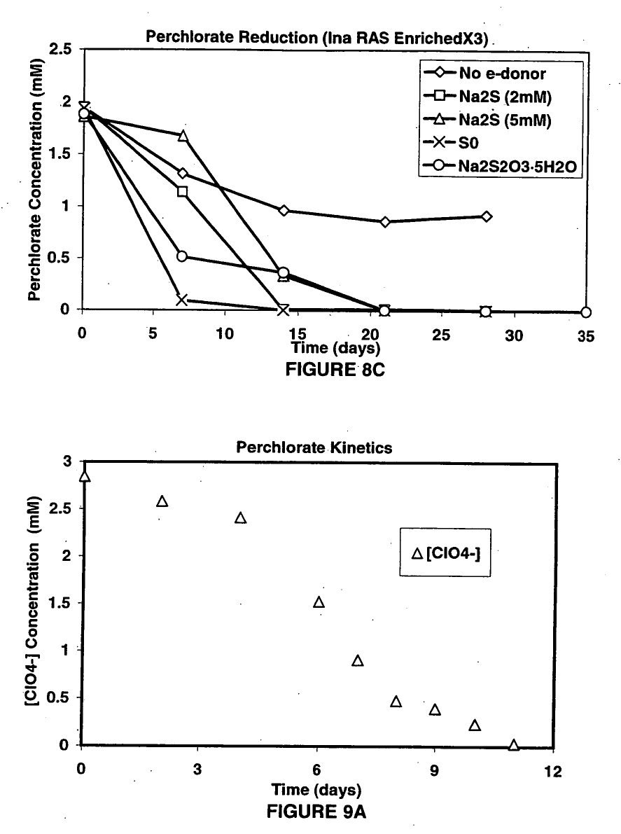

In order to increase the perchlorate-reducing activity of the inoculum used, a three-transfer enrichment culture of sulfur and Ina Aerobic inoculum was prepared and its perchlorate-reducing activity was compared to Ina Aerobic inoculum and no inoculum. FIGS. 6A-8C show the results of these experiments and demonstrate the increased effectiveness of the enrichment culture for perchlorate reduction.

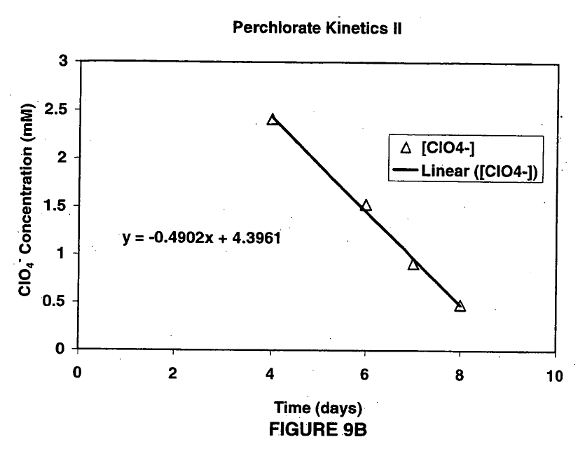

In order to construct a bioreactor design model for a biofilm reactor, a reasonable estimate of the zero-order maximum rate constant for perchlorate was needed. To this end, a fifth enrichment culture was prepared and added to a mineral medium containing elemental sulfur and perchlorate. The amount of inoculum added was small, and the assumption was made that it took some time before the enzyme level built up to a level where the zero-order maximum rate was being approximated by the curve. The complete plot is FIG. 9A; a linear portion midway through the experiment was chosen as the approximate zero-order region. The slope of that line should be a conservative estimate of the zero-order maximum rate. Since the reaction was run at 30° C., the estimate for 20° C. was taken to be 50% of the estimated value taken from the plot. The estimated zero-order maximum rate constant (k_{ClO4}) for perchlorate reduction was 0.170 mg ClO₄⁻ per minute per gram volatile suspended solids (VSS-min)⁻¹, where VSS is taken to be the mass of viable bacteria. It should be noted that actual zero-order maximum rates are subject to environmental factors such as water chemistry and populations of different microbes in a particular consortium. Often movement of a culture to another site for use as an inoculum produces different results. It is still useful, however, to have a conservative estimate as a starting point for modeling bioreactor performance.

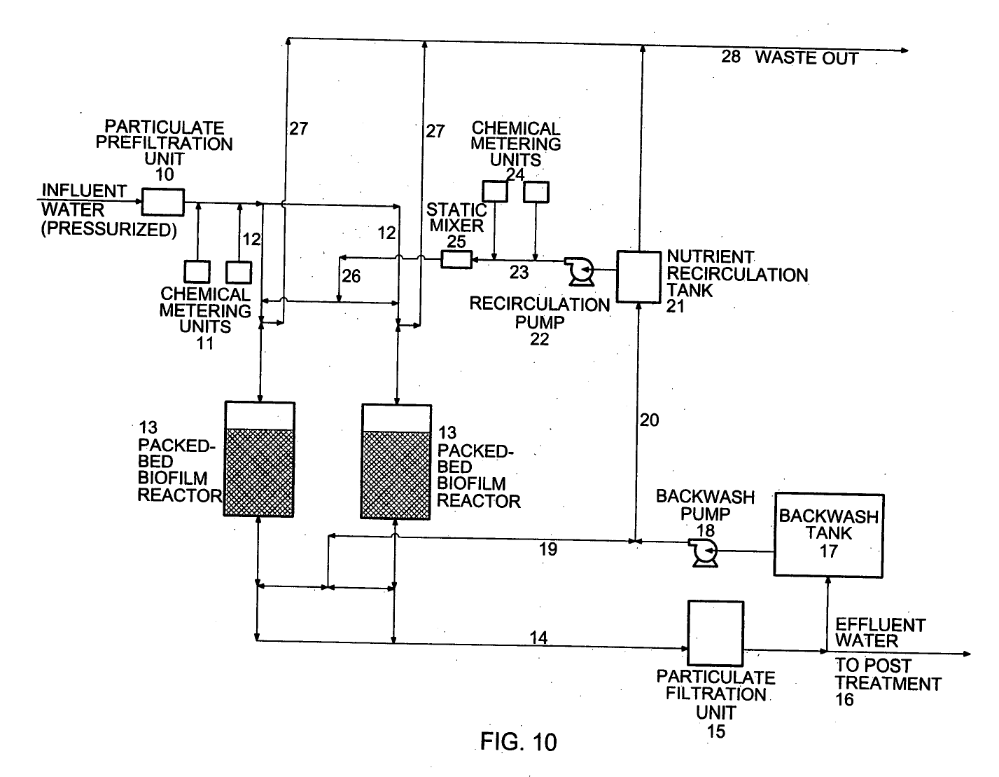

In an exemplary system for practicing the process, the bioreactor is ex-situ, including a vessel designed to contain the microbes, support material, sulfur source, and fluids, to withstand the weight of the bioreactor, contained fluids, and support materials and the pressures associated with the influent and effluent fluids; and to maintain anaerobic conditions sufficient to carry out the bioreduction of perchlorate in water or other feed material placed in or passed through the vessel. That system is shown in FIG. 10, and is described in more detail below.

The bioreactor preferably includes a support material upon which a microbially-populated biofilm can grow, such material comprising elemental sulfur or other solid or porous material familiar to those experienced in the art of bioreactor technology; and a microbially-populated biofilm that comprises aggregations of the microbes and their extracellular polymers that grow during an incubation period prior to or during operation of the bioreactor. The perchlorate reduction reaction takes place predominantly in the biofilm that is developed during an inoculation and incubation period and that coats the support material. This type of reactor is called a biofilm reactor and can be operated as a packed-bed bioreactor, upflow, downflow or sideflow, or, in a third embodiment, as a fluidized-bed bioreactor. The concepts and principles of packed-bed and fluidized-bed bioreactors are well known to the practitioners of biotechnology and are extensively discussed in Rittman and McCarty (2001).

The material used for supporting the microbial biofilm within the ex-situ bioreactor is preferably an inert material, such as activated carbon, sand, plastic, pumice, or other material familiar to those experienced in the art; more preferably elemental sulfur; or some combination of the foregoing materials. The material is preferably high surface-area to allow for maximum biofilm growth area, commonly accomplished by utilizing small, well-sorted particles, preferably 0.1 to 3.0 cm in diameter, more preferably 1 to 5 mm, while minimizing pressure drop through the bioreactor. Particles that are larger or smaller than the preferred range can also be used in embodiments designed to accommodate a large pressure drop or to reduce pressures by utilizing low flows, increasing cross-sectional area, increasing permeability, or other strategies known to practitioners of bioreactor technology. Particulate limestone or other granular mineral carbonate may optionally be incorporated into the elemental sulfur or other support material to allow for correction of reduced alkalinity and pH associated with the oxidation of sulfur and to supply trace nutrients. Reduced alkalinity and pH can also be corrected by standard pH control methods such as adding a strong or weak base to the influent water or to the reactor itself using chemicals such as sodium hydroxide, sodium bicarbonate, sodium carbonate or other materials used for pH control by practitioners of the art.

A fluidized-bed version of a system for practicing the principles of the invention comprises operation of the ex-situ biofilm reactor in an upflow mode, where the influent perchlorate-containing water is injected at sufficient volumetric flow rate to lift (fluidize) the particle bed resulting in suspension of the biofilm-covered particles in the influent perchlorate-containing fluid. The particles used in this embodiment may be sulfur particles, sulfur/limestone particles, or inert particles preferably resistant to abrasion. The advantage of this embodiment is that backpressures are less, allowing the use of smaller particles, on the order of 1 mm or less, thereby providing a higher surface to volume ratio, a higher surface area for the biofilm, and consequently higher rates of perchlorate reduction. The velocities required for bed fluidization may be high enough to require effluent recycle, which adds to the cost and offsets to some degree the advantage of faster rates. Losses of biofilm and of sulfur may also be a problem owing to the abrasion effected by moving particles.

Another exemplary embodiment for practicing the principles of the present invention is a process where the bioreactor is in-situ, and comprises a natural container such as saturated or unsaturated geologic materials, or an excavation into saturated or unsaturated geologic materials, or an impoundment or surface-water body wherein the conditions to conduct bioreduction of perchlorate by chemolithotrophic sulfur-oxidizing microbes are created. This type of reactor can also be a biofilm reactor. The material used for supporting the microbial biofilm within the in-situ bioreactor preferably comprises soil or other geologic material, more preferably a high surface area inert material or elemental sulfur. An example of such an embodiment would be a trench constructed and packed with particulate sulfur and located in such a manner to allow perchlorate-containing groundwater to flow through this source of electron donor. As a second example of such an embodiment, a source of sulfur such as a water solution of thiosulfate or a water suspension of fine-particle or colloidal sulfur would be injected into saturated or unsaturated zone soils to reduce perchlorate within or passing through the volume of soil receiving the source of sulfur. Inoculation of either of these embodiment examples with chemolithotrophic sulfur-oxidizing perchlorate-reducing microbes would be accomplished either by inoculating the sulfur source, the influent water, or by relying on resident in-situ chemolithotrophic sulfur-oxidizing perchlorate-reducing microbes to provide the inoculum.

The sources of sulfur used as electron donor in this invention include elemental sulfur and also any inorganic compounds such as thiosulfate (S₂O₃⁻) that can be microbially or otherwise disproportionated (Xu and others, 1995) to supply the elemental sulfur used to oxidize perchlorate, and this invention includes their use with possible embodiments of the process. A compound such as thiosulfate provides a more soluble form of sulfur than elemental sulfur itself, and its use would be applicable to an embodiment where the rate of bioreactor perchlorate reduction or the delivery of elemental sulfur to a perchlorate-contaminated matrix is hampered by the low solubility of elemental sulfur. Koenig and Liu,(2001b) observed that addition of a stoichiometric amount of thiosulfate increased the denitrification rates in an chemolithotrophic sulfur bioreactor by a factor of approximately seven, and similar results would be expected using perchlorate as the electron acceptor.

The microbial consortium of sulfur-oxidizing, perchlorate-reducing chemolithotrophic microbes is established by inoculating the bioreactor in a variety of ways: (1) By allowing the naturally occurring microbes present originally in the bioreactor or influent water to attach and grow on the substrate/support; (2) by collecting the naturally occurring microbes in the matrix, culturing the microbes ex-situ in a laboratory environment, then inoculating the bioreactor with the culture by adding it to the matrix, optionally amended with inorganic nutrients; or (3) by inoculating the bioreactor with a known perchlorate-reducing, sulfur-oxidizing microbial population cultured under laboratory conditions, optionally amended with inorganic nutrients.

The incubation comprises providing conditions that stimulate growth of the sulfur-oxidizing, perchlorate-reducing microbial consortium for a sufficient period of time to develop a biofilm that attains near steady-state reduction or otherwise meets the project-specific requirements of perchlorate reduction. Near steady-state operation of the bioreactor is attained when its rate of microbial population growth is approximately balanced by its rate of microbial population die-off. The incubation process consists of supplementing the bioreactor or influent water with suitable electron acceptors such as chlorate, more preferably with perchlorate, if insufficient; with nutrients and trace inorganic and organic compounds, if insufficient, and adjusting pH and temperature, if outside the preferred range; to stimulate growth of the microbial consortium. The preferable concentrations of the perchlorate or other suitable electron acceptors are a total of approximately 100 mg/L or more, which should be adjusted upward as the bioreactor perchlorate degradation efficiency improves in order to maintain an effluent concentration of preferably 2 or more mg/L, more preferably, 50 or more mg/L; the preferable concentrations of inorganic carbon nutrients (bicarbonate and carbonate) are approximately 10-20 mg/L or more (as carbon) per 100 mg/L perchlorate; the preferable concentrations of inorganic nitrogen (ammonium ion) are approximately 2 mg/L or more (as nitrogen) per 100 mg/L perchlorate, and the preferable concentrations of inorganic phosphorous (phosphate) are approximately 0.2 mg/L or more per 100 mg/L perchlorate. The preferable species and concentrations of inorganic and organic trace elements are those normally provided in the incubation phase of bioreactors practiced by those experienced in the art. Lower concentrations of these electron acceptors and nutrients will result in slower attainment of steady-state perchlorate reduction, but may be justified where electron acceptor or nutrient supplementation is difficult, for example, in in-situ bioreactors where a delay in reaching steady state or a lower biodegradation rate is justified by reduced costs of implementation. The preferable temperature of the bioreactor is believed to be at least 5° C., more preferably within the range of 20-35° C. The preferable pH is believed to be within the range of 5 to 9, more preferably within the range of 6 and 8.5.

As an example, from equation (1), we see that, based on perchlorate alone, treating the perchlorate levels typically found in contaminated drinking water (usually less than 1 mg/L) will negligibly affect water concentrations of chloride, sulfate, pH and alkalinity. However, the microbial consortium also has the ability to use dissolved oxygen and nitrate as electron acceptors, both of which also consume sulfur, contribute sulfate, and consume alkalinity; and these reactions need to be accounted for in design and operation of the bioreactor. The overall reaction for chemolithotrophic reduction of nitrate by sulfur-oxidizing bacteria is shown in Equation (2):
5S⁰+6NO₃⁻30 2H₂O=5SO₄²⁻+3N₂+4H⁺ (2)
where NO₃⁻ and N₂ are nitrate and nitrogen, respectively. The overall reaction for chemolithotrophic reduction of oxygen is shown in Equation (3):
S⁰+3/2O₂+2H₂O=2SO₄²⁻+4H⁺ (3)
where O₂ is molecular oxygen. The consumed concentrations of the three electron-acceptor components and the consequent increased concentration of sulfate are shown by Equation (4):
mg/L(SO₄²⁻)=1.29×mg/L(ClO₄⁻)+1.29×mg/L(NO₃⁻)+4.00×mg/L (O₂) (4)
and the total alkalinity consumed by the reduction of the three electron acceptors is given by Equation (5):
−alk(CaCO₃)=1.34×mg/L(ClO₄⁻)+0.537×mg/L(NO₃⁻)+4.17×mg/L (O₂) (5)

As an illustrative example, a groundwater analysis obtained from a representative perchlorate-contaminated (Southern California) well reported concentrations of 176 mg/L alk(CaCO₃), 31 mg/LS₄²⁻, 0.060 mg/L ClO₄⁻, 5.4 mg/L NO₃⁻, and 8 mg/L dissolved O₂. Based on equations Eq1 to Eq5, treatment of this water by the chemolithotrophic sulfur-oxidizing microbial consortium in the bioreactor would decrease alkalinity by 36 mg/L alk(CaCO₃) and increase sulfate by 39 mg/L SO₄²⁻, and result in an effluent concentration of 140 mg/L alk(CaCO₃), 70 mg/L SO₄²⁻, acceptably low levels of perchlorate, and negligible levels of nitrate and dissolved oxygen.

The oxidation of the electron acceptors in the above example results in effluent water concentrations of sulfate and alkalinity that do not exceed normal water quality standards. However, a much higher level of any or all of these electron acceptors, including perchlorate, could produce enough additional sulfate to exceed the current, secondary maximum contaminant limit (MCL) of sulfate in drinking water. The United States Environmental Protection Agency water-quality standards promulgated under the Safe Drinking Water Act specify a secondary MCL for sulfate of 250 mg/L in drinking water, based on aesthetic effects (i.e., taste and odor). While this regulation is not a federally enforceable standard, but is provided as a guideline for states and public water systems, exceeding this MCL could limit the application of this process for drinking water or require further water treatment.

Also, where influent nitrate or perchlorate concentrations are high or where waters have low natural alkalinity, the acid generation of the process could produce unacceptably low pH levels in the effluent water. Koenig and Liu (2001 a) point out that the optimum pH range for the growth of Thiobacillus denitrificans, a denitrifying chemolithotrophic sulfur-oxidizing bacteria, is 6.8 to 8.2. A lower pH than 6.8 in the effluent water could be restored to within the optimal range by adding a basic chemical such as a hydroxide, bicarbonate or carbonate or by incorporating particulate limestone in the sulfur matrix used by the microbes for biofilm support and growth. The use of limestone to neutralize acidity in bioreactors that denitrify high-nitrate waters by sulfur-oxidizing bacteria is well known to practitioners of the art (Darbi and others, 2003; Koenig and Lui, 2002). Acid production will be partially offset by deoxygenating the water before it enters the bioreactor, which could be sufficient treatment for marginally-low pH or alkalinity systems.

During steady-state operating conditions the biofilm thickness in packed-bed, chemolithotrophic, sulfur-oxidizing biofilm reactors tends to stabilize.

Experimental sulfur denitrification studies have shown that this thickness is kept lower than approximately 70 microns (Fleer and Zhang, 1999), or 40 or 30 microns (Koenig and Liu, 2001b; Batchelor and Lawrence, 1978). If the biofilm becomes too thick, then porosity and hydraulic conductivity are decreased to the point that the bioreactor needs to be backwashed to dislodge excess organic matter. However, properly maintained fixed-film reactors employing sulfur-oxidizing microbes have been shown by many practitioners of the art to not require extensive backwashing (Koenig and Liu, 2001b; Fleer and Zhang, 1999).

Fleer and Zhang (1999) observed that chemolithotrophic sulfur denitrification bioreactors operated for extended periods at influent nitrate concentrations as high as 130 mg/L, attained biofilm thicknesses of no more than 70 microns, and exhibited no biofouling. We believe that a bioreactor employing chemolithotrophic reduction of 100 mg/L or less of total electron acceptors including perchlorate by a sulfur-oxidizing microbial consortium will also exhibit sub-100 micron biofilms and negligible biofouling.

The influent water entering the bioreactor should normally provide sufficient inorganic carbon, nitrogen, phosphorous, and trace elements to allow for optimum biofilm thickness with low sludge production, needing only periodic sulfur replenishment, typically on a semi-annual to annual basis. If more nutrients are deemed necessary to maintain biofilm thickness than are provided in the specific influent water, these can be added to the influent water. Where influent concentrations of the nutrient electron acceptors do not stimulate sufficient microbial growth to maintain biofilm thickness, then either the influent concentration of electron acceptors such as chlorate or nitrate may need to be increased or the bioreactor will need to be periodically taken off line and recirculated with a solution containing needed nutrients.

### Description of an Exemplary System

FIG. 10 schematically illustrates an exemplary system that operates by the principles of the subject invention, providing treatment of perchlorate-containing water by a packed-bed sulfur chemolithotrophic biofilm reactor. For purposes of simplifying the schematic diagram, the appropriate valving is not included; rather, allowed flow directions are indicated by arrows at the end of line segments. The influent water is assumed to contain 100 micrograms per liter (μg/L) perchlorate, 10 mg/L nitrate, 8 mg/L dissolved oxygen, 50 mg/L sulfate, and 150 mg alkalinity, as CaCO3. The target treatment goal is assumed to be 1.0 μg/L. Each bioreactor is a 250 gpm, 12-ft diameter, 23-ft high fully enclosed, packed bed reactor column constructed from materials appropriate to those skilled in the art. The column contains approximately 91 tons of 3 millimeter (mm) mean-diameter sulfur particles based on sulfur's density of 2.07 grams/cm³ and an estimated porosity of 0.35 (35% void volume). The reactor column is pressurized and certified to a pressure rating suitable for the site application and is equipped with a series of taps for instrumentation ports or sampling. The schematic is an example of a system that can handle a system flowrate of 250 gallons per minute. For greater flow volumes further multiples of reactors, in parallel, would be used. For example, a total flow rate of 1000 gpm would use four of these reactors online at one time and include a fifth reactor to allow periodic shutdown and maintenance of an individual reactor column while still continuing water treatment. This system is an example of a version of the invention that does not require continuous addition of substrate (i.e., elemental sulfur). Thereby reducing maintenance requirements.

A potential problem with biological treatment of nitrate-containing water is the production of nitrogen bubbles in the reactor, which decreases the liquid-filled porosity and the hydraulic conductivity of the reactor material, and also reduces the degradation rate of target contaminants by blocking solution access to the biofilm or by hydrodynamic stripping of the biofilm, leaving bare areas on the substrate. The bubbles are produced wherever the aqueous solubility of nitrogen is exceeded in the reactor. In this embodiment of the invention, that problem is resolved by introducing the influent water at the water system pressure. Assuming the nitrogen (N²) in influent water to be in equilibrium with the atmosphere, the concentration of nitrogen will be equal to 0.78 of the saturation value for nitrogen at atmospheric pressure. When the water is put under pressure by the drinking water system, the saturation value for nitrogen is increased by the ratio of the sum of system pressure and atmospheric pressure to atmospheric pressure. Therefore the influent water has a large excess capacity for dissolved nitrogen and the excess nitrogen produced by biological processes dissolves without the production of bubbles.

A further advantage of having an enclosed pressurized system is that the hydraulic pressure of the incoming water is maintained (pressure head loss in the bioreactor is minimal) which removes the need for pump installations and extra power to increase pressure of the effluent water to that necessary to supply the drinking water system. Yet another advantage of having an enclosed system is the security provided by preventing easy access to the bioreactors by unauthorized individuals.

The pressurized influent water first passes through an optional particulate prefiltration unit 10 to remove suspended matter. After the water passes through the prefiltration unit, chemical metering pumps 11 add any necessary inorganic nutrients, other growth factors, or alkalinity compensating chemicals (such as sodium bicarbonate) as determined by site-specific requirements. The water then flows via piping 12 into the bioreactor columns 13 in a downflow mode through individual connections. The effluent perchlorate-reduced water then passes via piping 14 through a high rate particle filtration system 15 such as a sand, bag, or other filter familiar to practitioners of the art and directed to the water system and any post treatment via piping 16. The filtered perchlorate-reduced water is periodically directed to a backwash tank 17. Should a reactor column backwash be required, a backwash pump 18 directs water from the backwash tank 17 via piping 19 upflow through the bioreactors 13. Particulates clogging the filter bed will likely be removed by a flow rate less than required to fluidize the bed. If not, or in the unlikely event of biofouling, flow at a higher rate is necessary to fluidize the bed, unclog the reactor column, and/or detach excess biofilm from the sulfur substrate. The backwash effluent is directed via piping 27 to plant waste by separate piping 28. The backwash pump 18 also provides the perchlorate-reduced and filtered water via piping 20 to a nutrient recirculation tank 21. When necessary, a recirculation pump 22 then recirculates the water via piping 23 into a static mixer 25 after chemical metering units 24 add nutrients. The nutrient-fed water then is pumped to the influent lines 12 of each individual reactor column via line 26 to allow for nutrient addition if required. The water then continues through each reactor and back to the recirculation tank via piping 19 and 20. The nutrient recirculation tank 21 has an additional line connected to the waste line 28 to allow for drainage.

A bioreactor design model was constructed according to equations developed by Arvin and Harremoës (1990). This model, based on first-order decay kinetics regarded as appropriate for the low perchlorate concentrations typically encountered in drinking water sources, was applied to the preferred embodiment shown schematically in FIG. 10, using the water chemistry as given in paragraph [0056]. The model results are listed in Tables 1 and 2.

Following Arvin and Harremoës (1990), the first-order perchlorate reaction rate in the biofilm, ¹k_{ClO4f} (min⁻), can be estimated from
¹k_{CLO4f}=k_{ClO4}Xₐ/K_{ClO4} (6)
where K_{ClO4} is the zero-order maximum rate constant (mass perchlorate per mass volatile suspended solids (VSS) per minute; Xₐ is the VSS concentration (mass VSS per unit volume) in the biofilm, and K_{ClO4} is the half maximum rate concentration for perchlorate (mass ClO₄⁻ per unit volume water). Using the experimentally determined estimate for the zero-order maximum rate constant of 0.170 mg ClO₄⁻ /gm VSS-min, the concentration of VSS in the biofilm (estimated from averaged literature values (Rittman and McCarty, 1992) to be 0.04 gm VSS/cm³ biofilm) and an assumed half-maximum rate concentration (Kₛ) of 0.003 mg/cm³, the calculated first-order reaction rate ¹k_{ClO4} f in the biofilm is 2.27 min⁻¹. Using the conservative value for the first-order reaction rate ¹k_{ClO4f} f in the biofilm of 2.27 min⁻¹ and a steady-state biofilm thickness of 0.0025 cm, we arrive at a first-order reaction rate in the bioreactor of 0.3539 mg ClO₄⁻/min-cm³ bioreactor column packing.

For a flow rate of 250gpm through each reactor column,.the hydraulic residence time in the packed-bed sulfur column, including a safety factor of 1.2, is 16.2 minutes. The model indicates that an influent perchlorate concentration of 100 μg/L would be reduced to the target level of 1.0 μg/L in the reactor column in 16.2 minutes, well before the influent water is discharged to the bioreactor effluent tank and would be reduced to 0.1 μg/L in the full 22.5 minute residence time. Nitrate and oxygen concentrations will be less than 0.1 μg/L. Sulfate levels will have increased to 123 mg/L and alkalinity will have decreased to 89 mg/L (as CaCO₃).

### Additional Embodiments of the Process

Practitioners of the art will recognize the fact that a biological process applied using a reactor may use different reactor configurations depending on need and circumstance. Such additional embodiments may be used with this invention in various arrangements and combinations. We discuss below some additional systems that can be constructed to practice the principles of the present invention.

Initially, bioreactors are generally designed for either suspended growth or biofilms.

The exemplary system described above is one type of a biofilm reactor. Bioreactors may be configured to recycle effluent, to run in series or parallel with some suspended growth and some biofilm reactors, or combined as hybrid reactors.

Another embodiment that operates under the principles of the present invention is the simplest suspended-growth reactor known as a batch reactor. The reactor is filled with the perchlorate-containing matrix in the form of a liquid or soil slurry, elemental sulfur and/or a more soluble sulfur, the microbial culture, and nutrients. The reactor contents are stirred if necessary to keep the contents in suspension. Gases can be introduced if needed. The reactor is then run in batch with no additional material being added until the reaction is complete or the target level of perchlorate has been reached. The kinetics of a batch reactor can lead to highly efficient removal of a contaminant. When several batch reactors are operated in parallel, the system is termed sequencing batch reactors. Some can be filling, some can be emptying, and some can be treating, which allows continuous flow through the system, even though it is a batch treatment. This process allows a single reactor or multiple reactors to operate aerobically and then anaerobically if such action is deemed necessary.

Yet another system that can operate under the principles of the present invention is the continuous-flow stirred-tank reactor (CSTR). The perchlorate-containing marix, again in the form of a liquid or slurry stream, is continuously fed into the reactor along with elemental sulfur and/or a more soluble partially oxidized sulfur compound, and, optionally, nutrients; the reacted contents are continuously removed from the reactor. Depending on conditions, microbial culture may or may not be added to the reactor during normal operation. If the CSTR is operating properly, the concentrations of electron donor substrate, microorganisms, and nutrients are the same everywhere in the reactor.

Still another system that can operate under the principles of the present invention is a plug-flow reactor (PFR). Similarly with the CSTR, the perchlorate-containing matrix (as a liquid or slurry stream), electron donor substrate (elemental or partially oxidized sulfur), nutrients, and microorganisms continuously enter one end of the reactor and leave at the other. Because the microorganisms must be introduced at the influent end of the PFR, this is normally accomplished by effluent recycle; a portion of the microorganisms in the effluent is brought back to the influent stream. The flow (in the ideal PFR), however, moves through the reactor with no mixing of prior or later entering flow; each portion of the flow stream entering at the same time moves through the reactor as a “plug”, hence the terminology “plug-flow”. The concentrations of electron donor substrate and microorganisms vary throughout the reactor, in contrast to the CSTR.

All of the above embodiments can be used in recycle mode, in parallel for redundancy and to handle high flow rates, in series, and as part of hybrid configurations.

While the foregoing description has discussed a preferred embodiment for the removal of perchlorate from water, it should be apparent to practictioners of the art that the invention has applicability for treatment of other oxidized contaminants in a matrix. It is known that strains of sulfur-oxidizing bacteria can grow anaerobically, using nitrate as an electron acceptor. [Madigan, 2003] The present invention clearly demonstrates the ability of chemolithotrophic sulfur-oxidizing bacteria growing under anaerobic conditions to grow using an electron acceptor other than nitrate; in this case perchlorate. Those versed in the art will recognize that the ability of a chemolithotrophic bacteria to grow using more than one specific electron acceptor leads to the strong possibility of utilizing still other electron acceptors provided the reduction of that substrate is thermodynamically favorable under the conditions within the bioreactor; provided also that the consortium or strain of bacteria possesses the necessary enzyme system to reduce the electron acceptor; and further provided that the effect of reducing the electron acceptor provides the oxygen necessary to oxidize the elemental sulfur, the electron donor used by the chemolithotrophic bacteria. The applicants have concluded that the principles of the present invention can be used for the reduction of the following additional oxidized species: pertechnate (TcO₄⁻), arsenate (H₂AsO4⁻), chromate (CrO₄²⁻), bromate (BrO₃⁻), chlorite (ClO₂⁻), chlorate (ClO₃⁻), and uranium(VI) oxide, which exists in solution as a carbonate complex, (UO₂(CO₃)₂²⁻). Table 3 lists probable reactions for reduction of these oxidized compounds with concurrent oxidation of elemental sulfur:

TABLE 3

| Compound | Probable Reduction Reaction(s) |
|---|---|
| Arsenate | 3H₂AsO₄⁻ + S⁰ + H₂O + H⁺ = SO₄²⁻ + 3H₃AsO₃ |
| Bromate | BrO₃⁻ + S⁰ + H₂O = Br⁻ + SO₄²⁻ + 2H⁺ |
| Chlorate | ClO₃⁻ + S⁰ + +H₂O = Cl⁻ + SO₄²⁻ + 2H⁺ |
| Chlorite | ClO₂⁻ + S⁰ + 2H₂O = Cl⁻ + SO₄²⁻ + 4H⁺ |
| Chromate | 2CrO₄²⁻ + S⁰ + 2H₂O + 2H⁺ = SO₄²⁻ + 2Cr(OH)₃ |
| Pertechnate | TcO₄⁻ + S⁰ = TcO₄⁻ + SO₄²⁻ |
| Uranium(VI) | 3UO₂(CO₃)₂²⁻ + 4H₂O + S⁰ = SO₄²⁻ + 3UO₂ + |
| | 6CO₃²⁻ + 8H⁺ |

Each of the additional oxidized species are known to be biologically reducible. Specific instances are the reduction of U(VI) to U(IV) with a microbial consortium that included two indigenous denitrifying bacteria and one sulfate reducing bacteria. [Adbelouas et al, 1998]; reduction of pertechnate to TcO₂ by Fe(III) reducing bacteria [Lloyd et al ,2000]; pertechnate is precipitated abiotically as well in a reducing environment as TcO₂; reduction of arsenate to arsenite (H₃AsO₃) with a denitrifying bacteria [Santini et al, 2002]; reduction of bromate to bromide by denitrifying bacteria in a denitrifying bioreactor using an organic substrate as the electron acceptor [Hijnen et al, 1999]; the applicants also have preliminary results of using the present invention to reduce bromate to bromide; and reduction of chlorite and chlorate as two-electron reduction intermediate products during complete degradation of perchlorate to chloride and oxygen using organic electron acceptors such as acetate [Rikken et al, 1996].

These instances confirm the existence of microbial enzyme systems that can effect reduction of the additional oxidized species listed above, as well as indicating that thermodynamically favorable conditions exist for such reductions in environments with actively growing microbial populations.

Microorganisms can exchange genetic information, which has been found to take place at high rates in natural settings. In fact the high rates observed call all of bacterial taxonomy into question. The view that is emerging is that speciation at the microbial level is not possible; rather one speaks of strains rather than species of microbes, because the bacterial genes are being mixed too rapidly for conventional taxonomy to describe the reality. Microbes can exchange genetic information in three ways: conjugation, transformation, and transduction. The most important is conjugation, which involves the replication and transfer of plasmid DNA from donor cell to recipient cell. The result is that both cells contain the plasmid. Such transfers proliferate genes throughout the microbial community, even when there is no net growth. Plasmids contain genes that code for many environmental factors, including the detoxification of hazardous compounds and elements. Some plasmids transferred through conjugation are transferable to a wide variety of other bacteria, as well as physiologically distantly related organisms, including fungi and plant cells. Even if the plasmid cannot replicate in the new host, transfer of its DNA could have important evolutionary consequences if it can recombine into the genome of the new host. Several instances have been documented which noted that a conjugative plasmid encoding genes for degradation of a specific contaminant found in a host bacteria introduced into a contaminated situation did not survive after time, but the plasmids were found to have transferred to a wide range of indigenous bacterial strains, including one case where the plasmids were identified at distances greater than 20 km from the original inoculation.

Briefly, the other two methods are transformation, when free DNA from the environment is incorporated into the chromosome of the recipient cell. For a cell to integrate the free DNA into its chromosome is not a normal situation;

nevertheless, measurements suggest that such DNA is relatively abundant in a microbial environment, and transformation has been demonstrated in many natural settings. Tranduction moves DNA from one cell to another by incorporating it into the DNA of a bacteriophage. Infection of another cell can sometimes incorporate it into the recipient's chromosome. [Bushman, 2002; Madigan et al, 2003; Rittmann, 2001]

To conclude, the ease and the high rate of genetic exchange between different types of bacteria, the demonstrated biological reduction of the aforementioned oxidized contaminants, the thermodynamically favored probable reduction reactions, and the availability of oxygen that can be transferred under anoxic conditions to allow for the oxidation of sulfur as the electron donor, strongly indicate the applicability of the invention process for the treatment of such oxidized contaminants.

With a process or bioreactor according to the present invention, a matrix composed of or containing any of the oxidized contaminants, a source of elemental sulfur to allow for contaminant reduction within the bioreactor by sulfur-oxidizing microbes; a consortium of sulfur-oxidizing, oxidized contaminant-reducing chemolithotrophic microbes which either occur naturally in the oxidized contaminant-bearing feed material or are introduced to the bioreactor by inoculation. The reduction of oxidized contaminants takes place in a bioreactor in the same way as described above with perchlorate in the perchlorate contaminated water. Specifically, oxidized contaminant contained in a matrix is reduced within the bioreactor, and elemental sulfur is oxidized to sulfate by a consortium of sulfur-oxidizing, oxidized contaminant-reducing microbes.

While a number of embodiments of the invention have been shown and described herein, it will become apparent to those skilled in the art that the list of embodiments presented here is not exhaustive and that various modifications and changes can be made in the process of chemolithotrophic reduction of the noted oxidized contaminants using sulfur-oxidizing microbes without departing from the spirit and scope of the present invention. All such modifications and changes coming within the scope of the appended claims are intended to be carried out.

### REFERENCES

Abdelouas, A., Lu, Y., Lutze, W., Nuttall, H., 1998. Reduction of U(VI) to U(IV) by indigenous bacteria in contaminated ground water. Journal of Contaminant Hydrology 35, 217-233.
Arvin, E., and P. Harremoës, 1990. Concepts and models for biofilm reactor performance. Water Science and Technology, 22, Number 1 of 2, pp. 171-192.
Batchelor, B. and A. W. Lawrence, 1978. Chemolithotrophic denitrification using elemental sulfur. J. Water Pollut. Control Fed., 50, 1986-2001.
Bushman, F., 2002. Lateral DNA Transfer: Mechanisms and Consequences. ISBN 0-86969-603-6, published by Cold Spring Harbor Laboratory Press, Cold Spring Harbor, N.Y.
Ceskova, P., Mandl, M., Helanova, S., Kasparovska, J., 2002. Kinetic Studies on Elemental Sulfur Oxidation by Acidithiobacillus Ferrooxidans: Sulfur Limitation and Activity of Free and Adsorbed Bacteria. Biotechnology and Bioengineering, 78, Number 1, pp. 24-30.
Chaudhuri, S. K., O' Connor, S. M., Gustavson, R. L., Achenbach, L. A. and Coates, J. D., 2002. Environmental Factors That Control Microbial Perchlorate Reduction. Applied and Environmental Microbiology, 68, Number 9, pp. 4425-4430.
Darbi, A., Viraraghavan, T., Butler, R., and Corkal, D., 2003. Column Studies on Nitrate Removal From Potable Water. Water, Air, and Soil Pollution, 150, Number (1-4), pp. 235-254.
Fleer, J. N., and Zhang, T. C., 1999. Nitrate Removal with Sulfur-Limestone Chemolithotrophic Denitrification Processes. Journal of Environmental Engineering, 125, Number 8, pp. 721-729.
Friedrich, C. G., Rother, D., Bardischewky, R., Quentmeier, A., and Fischer, J., 2001. Oxidation of Reduced Inorganic Sulfur Compounds by Bacteria: Emergence of a Common Mechanism? Applied and Environmental Microbiology, 67, Number 7, pp. 2873-2882.
Hijnen, W., Jong, R., van der Kooj, D., 1999. Bromate removal in a denitrifying bioreactor used in water treatment. Water Research 33 4, pp. 1049-1053.
Koenig, A. and L. H. Liu, 2001a. Microbial aspects of autrotrophic denitrification of wastewaters. In: Matgsuo, T., K. Hanaki, S. Takizawa, J. Satoh (Eds.), Advances in Water and Wastewater Treatment Technology: Molecular Technology, Nutrient Removal, Sludge Reduction and Environmental Health. Elsevier Science, Amsperdam, pp 217-226.
Koenig, A. And L. H. Liu, 2001b. Kinetic model of chemolithotrophic denitrification in sulfur packed-bed reactors. Water Res.35 (8), pp 1969-1978.
Koenig, A., and Liu, L. H., 2002. Use of limestone for pH control in chemolithotrophic denitrification: continuous flow experiments in pilot-scale packed bed reactors. Journal of Biotechnology, 99, Number 2, pp. 161-171.
Lloyd, J., Sole, V., Van Praagh, C., Lovley, D., 2000. Direct and Fe(II)-Mediated Reduction of Technetium by Fe(III)-Reducing Bacteria. Applied and Environmental Microbiology 66 9, pp 3743-3749.
Madigan, M., Martinko, J., Parker, J., 2003. Brock Biology of Microorganisms, Tenth Edition. ISBN 0-13-066271-2. Published by Pearson Education, Inc., Upper Saddle River, N.J.
Min, B., Evans, P. J., Chu, A. C., and Logan, B. E., 2004. Perchlorate removal in sand and plastic media bioreactors. Water Research 38, Number 1, pp. 47-60.
Nerenberg, R., Rittman, B. E., Gillogly, T. E., Lehman, G. E., and Adham, S. S., 2003. Perchlorate Reduction Using a Hollow-Fiber Membrane Biofilm Reactor: Kinetics, Microbial Ecology, and Pilot-Scale Studies. Paper C-08, in: Magar, V. S., and Kelley, M. E.(Eds.), In-situ and On-Site Bioremediation-2003. Proceedings of the Seventh International In-situ and On-Site Bioremediation Symposium (Orlando, Fla.; June 2003). ISBN 1-57477-139-6, published by Battelle Press, Columbus, Ohio.
Rikken, G., Kroon, A,. van Ginkel, C., 1996. Tranformation of (per)chlorate into chloride by a newly isolated bacterium: reduction and dismutation. Applied Microbiology and Biotechnology 45, pp. 420-426
Rittman, B. E. and McCarty, P. L., 2001. Environmental Biotechnology: Principles and Applications. ISBN 0-07-118184-9, published by McGraw-Hill Book Company, New York, N.Y.
Robertson, L. A., and Kuenen, J. G., 1992. The Colorless Sulfur Bacteria. In: Balows, A., et al (Eds.), The Prokaryotes, 2^{nd} nd Edition, Volume 1, Chapter 16, pp. 385-413. ISBN 0-38-797258-7, published by Springer-Verlag, New York, N.Y.
Roote, D. S., 2001. Technology Status Report: Perchlorate Treatment, Technologies. Ground-Water Remediation Technologies Analysis Center, Publication Number TS-01-01, Appendix.
Santini, J., Stoltz, J., Macy, J., 2002. Isolation of a new arsenate-respiring bacterium - physiological and phylogenetic studies. Geomicrobiology Journal 19 1, pp 41-52
Tichy, R., Janssen, A., Grotenhuis, J. T. C., Van Abswoude, R. and Lettinga, G, 1998. Oxidation of Biologically-Produced Sulfur in a Continuous Mixed-Suspension Reactor. Water Research 32 Number 3, pp. 701-710
Xu, Y., Schoonen, M., 1995. The Stability of thiosulfate in the presence of pyrite in low-temperature aqueous solutions. Geochimica et Cosmochimica Acta, 59, Number 22, pp. 4605-4622.

Xu, J., Yanguang, S., Min; B., Steinberg, L., and Logan, B. E., 2003. Microbial Degradation of Perchlorate: Principles and Applications. Environmental Engineering Science 20, Number 5, pp. 405-422.

TABLE 1
Spreadsheet of Input Parameters Used to Develop Chemolithotrophic Sulfur Biofilm
Reactor for Perchlorate Reduction

| Parameter | Value | Unit | Value Obtained From |
|---|---|---|---|
| Lₚ (Biofilm Thickness) | 0.0025 | centimeter (cm) | Estimate |
| d (Sulfur Particle Diameter of Base) | 0.35 | cm | Specified |
| h (Sulfur Particle Height) | 0.1 | cm | Specified |
| sᵣ (Surface area enhancement factor) | 6.50 | unitless | Ratio of particle area to spherical particle |
| | | | area (same volume) |
| p (Porosity of Bioreactor) | 0.35 | unitless | Estimate |
| Df_{ClO4} (Diffusion coefficient of ClO₄⁻ in biofilm) | 7.50E−06 | cm²/sec | 50% of aqueous diffusion coefficient |
| Df_{NO3} (Diffusion coefficient of NO₃⁻ in biofilm) | 7.50E−06 | cm²/sec | 50% of aqueous diffusion coefficient |
| Df_{O2} (Diffusion coefficient of O₂ in biofilm) | 7.50E−06 | cm²/sec | 50% of aqueous diffusion coefficient |
| k_{ClO4} (zero-order maximum rate constant) | 0.170 | mg-ClO₄/gm-VSS-min | 50% of lab measured umax corrected for T; |
| | | | y = 0.2 eeq/eeq |
| k_{NO3} (zero-order maximum rate constant) | 1.31 | mg-NO₃.N/gm-VSS-min | 50% of Vmax reported by |
| | | | Rittman & McCarty 2001 [pg 499] |
| k_{O2} (zero-order maximum rate constant) | 1.00 | mg-O₂/gm-VSS-min | Estimate Based on Literature |
| Xₐ (VSS concentration in biofilm) | 0.04 | gm-VSS/cm³ biofilm | Estimate [Rittman and McCarty, pg 220] |
| K_{ClO4} (half maximum rate concentration for ClO₄⁻) | 0.003 | mg/cm³ | Assumption |
| K_{NO3} (half maximum rate concentration for NO₃⁻—N) | 0.001 | mg/cm³ | Estimate Based on Literature |
| K_{O2} (half maximum rate concentration for O₂) | 0.001 | mg/cm³ | Estimate Based on Literature |
| °C_{ClO4} (influent perchlorate concentration) | 0.100 | mg/L | Site specific |
| °C_{NO3—N} (influent nitrate-N concentration) | 3.2 | mg/L | Site specific |
| °C_{O2} (influent oxygen concentration) | 8.0 | mg/L | Site specific |
| C_{ClO4} (effluent perchlorate concentration) | 0.001 | mg/L | Site specific |
| C_{NO3—N} (effluent nitrate-N concentration) | 1.000 | mg/L | Estimated based on Literature |
| C_{O2} (effluent oxygen concentration) | 0.800 | mg/L | Estimated based on Literature |
| °SO₄ (influent sulfate concentration) | 32 | mg/L | Site specific |
| °Alk (influent alkalinity, as CaCO₃) | 150 | mg/L | Site specific |
| Q (Influent flow rate) | 250 | gallons per minute (gpm) | Specified Input |
| D (diameter of bioreactor column) | 12 | ft | Specified Input |
| E_{c} (percent of design margin for packed sulfur column) | 20.0% | unitless | Specified Input |
| Fₒ (percent of free board for packed sulfur column) | 25.0% | unitless | Specified Input |

TABLE 2
Spreadsheet of Output Parameters Used to Develop Chemolithotrophic Sulfur
Biofilm Reactor for Perchlorate Reduction

| Parameter | Value | Unit | Value Obtained From |
|---|---|---|---|
| ¹k_{ClO4f} (1st-order ClO₄ reaction rate constant | 2.27 | min⁻¹ | ¹k_{CLO4f} = k_{ClO4}Xₐ/K_{ClO4} [Arvin & |
| in biofilm) | | | Herramöes (A&H), 1990] |
| ¹k_{NO3f} (1st-order NO₃ reaction rate constant in biofilm) | 52.4 | min⁻¹ | ¹k_{NO3f} = k_{NO3}Xₐ/K_{NO3} (A&H, 1990) |
| ¹k_{O2f} (1st-order O₂ reaction rate constant in bioflim) | 40.0 | min⁻¹ | ¹k_{O2f} = k_{O2}Xₐ/K₀₂ (A&H, 1990) |
| Sₐ (Surface area of particles/unit volume packed bed) | 62.4 | cm²/cm³ | Sₐ = (1 − p)(5 * d²/4 + h²)/(h(d²/8 + h²/6)) |
| alpha (if alpha <0.5, ¹r_{ClO4} = ¹k_{ClO4f}Lₚ) | 0.177 | unitless | alpha = (¹k_{ClO4f}Lₚ²/60Df_{ClO4})^{(1/2)} (A&H, 1990) |
| ¹r_{ClO4} (1st-order bioreactor ClO₄ rate constant) | 0.3539 | min⁻¹ | r_{CLO4} = ¹k_{ClO4f}Lₚ Sₐ (A&H, 1990) |
| ¹r_{NO3} (1st-order bioreactor NO₃ rate constant) | 8.1807 | min⁻¹ | r_{NO3} = ¹k_{NO3f}Lₚ Sₐ (A&H, 1990) |
| ¹r_{O2} (1st-order bioreactor O₂ rate constant) | 6.2448 | min⁻¹ | r_{O2} = ¹k_{O2f}Lₚ Sₐ (A&H, 1990) |
| SO₄ (effluent sulfate concentration) | 66 | mg/L | SO4 = °SO₄ + 1.29°C_{ClO4} + 5.71°C_{NO3—N} + 2.0°C_{O2} |
| Alk (effluent alkalinity, as CaCO₃) | 108 | mg/L | Alk = °Alk − 1.34°C_{ClO4} − 2.79°C_{NO3—N} − 4.17°C_{O2} |
| H_{ClO4} (Height of bioreactor column for ClO₄) | 10.988 | ft | H_{ClO4} = −4Qtn(C_{ClO4}/°C_{ClO4})/ |
| | | | 7.48¹r_{ClO4}(πD²p) (A&H, 1990) |
| H_{NO3} (Height of bioreactor column for NO₃) | 0.120 | ft | H_{NO3} = −4Qtn(C_{NO3—N}/°C_{NO3—N})/ |
| | | | 7.48¹r_{NO3}(πD²p)(A&H, 1990) |
| H_{O2} (Height of bioreactor column for O₂) | 0.311 | ft | H_{O2} = −4Qtn(_{O2}/°C_{O2}/7.48¹r_{O2}(πD²p) (A&H, 1990) |
| H (Total height of bioreactor column) | 17.1 | ft | H = (1 + E_{c}) * (1 + F_{c}) * (H_{ClO4} + H_{NO3} + H_{O2}) |
| V (Bioreactor column volume) | 1937 | ft³ | V = 3.1416(D/2)²H |
| Sₘ (mass of sulfur contained in bioreactor) | 65.0 | tons | Sₘ = V * 2.07 * (1 − p) * 28.3/((1 + F_{c}) * |
| | | | 0.454 * 2000) |
| HRT_{S} (Hydraulic Retention Time in sulfur media) | 16.2 | min | HRT_{S} = 7.48pV/(Q * (1 + F_{c})) |
| S (Sulfur Particle Packing Media Loss per Day) | 34.4 | lbs/day as Sulfur | S = 8.34 * Q * (SO₄ − °SO₄)/10⁶ * 32/96 * 1440 |
| A (Alkalinity Loss per Day) | 127.4 | lbs/day as CaCO₃ | A = 8.34 * Q * (Alk − °Alk)/10⁶ * 1440 |
| R_{H} (Hydraulic Loading Rate) | 1.6 | gpm/ft² | R_{H} = Q/(πD²p) |
| W_{NaHCO3} (NaHCO₃ to compensate for Alkalinity Loss) | 214.0 | lbs/day | W_{NaHCO3} = A * 84/50 |
| C_{NaHCO3} (Cost per 1000 gal water treated) | 0.238 | $/1,000 gal | C_{NaHCO3} = W_{NaHCO3} * 0.4/(Q * 1.440) |
| HRT_{R} (Hydraulic Retention Time in entire reactor) | 57.96 | min | HRT_{R} = 7.48 * V/Q |
| Lᵥ (Biofilm volume) | 0.156 | cm³/cm³_{reactor} | Lᵥ = Sₐ * L |
| design biomass concentration | 6.245 | gm VSS L⁻¹ _{packedbed} | |
| b (endogenous decay coefficient) | 0.025 | day⁻¹ (d⁻¹) | ½ the Rittman McCarty autotrophic denitrif |
| | | | biofilm 20° C. |
| biomass decay rate | 0.156 | gm VSS/L_{packedbed} d⁻¹ | |
| Y (yield coefficient) | 9.059E−05 | gm VSS mg⁻¹ ClO₄⁻ | calculated from Y = 0.2 eeq cells/eeq ClO₄⁻ |
| L_{flow} L⁻¹_{packedbed} d⁻¹ in ClO₄⁻ section | 38.7 | d⁻¹ | |
| HRT in ClO₄⁻ section | 37.18 | min | |
| mg ClO₄⁻ L⁻¹_{packedbed} d⁻¹ in ClO₄⁻section | 3.87 | mg ClO₄⁻/L_{packed bed} d⁻¹ | |
| biomass synthesis ClO₄⁻ reducers per L_{packedbed-}day | 0.00035 | gm VSS/L_{packedbed} d⁻¹ | |
| Equllibrium biomass concentration | 0.01403 | gm VSS/L_{packedbed} | |
| Biomass_{design}/Biomass_{equllibrium} | 445.0 | unitless | |
| HRT in ClO₄⁻ section with equllibrium biomass | 11.49 | d⁻¹ | |
| Time to 50% loss in activity | 27.73 | d | |
| Growth rate at 20 deg C | 0.044 | d⁻¹ | (assumes biofilm is 50% perchlorate reducing bacteria) |
| Time to restore 2X increase ClO₄⁻ reducers | 15.03 | d | |
| mg S° reduced mg⁻¹ COD | 2.0 | mg S°/mg COD | |
| Predicted H₂S concentration | 5.72 | mg H₂S/L | assume 50% eeq of decaying biomass reduces S° |

1. A process for treating the following oxidized contaminants contained in or introduced into a matrix: pertechnate (TcO₄⁻), arsenate (H₂AsO₄⁻), chromate (CrO₄²⁻), bromate (BrO₃⁻), chlorite (ClO₂⁻), chlorate (ClO₃), perchlorate (ClO₄⁻), and uranium (VI) oxide, comprising the steps of
a. providing a bioreactor that includes a source of elemental sulfur and a microbial population capable of using sulfur as an electron donor source to reduce the oxidized contaminants, and
b. performing biological reduction of the oxidized contaminants in the matrix by the microbial population of the bioreactor, with the elemental sulfur providing an electron donor source.

2. A process as defined in claim 1, including the step of attaining and maintaining anaerobic conditions in a portion of the bioreactor wherein sulfur is oxidized and the oxidized contaminant is reduced by the microbial population of the bioreactor.

3. A process as defined in claim 2, including the step of providing a support material for growth of the microbial population in the bioreactor.

4. A process as defined in claim 3, including the step of providing the bioreactor with inorganic nutrients and trace elements needed for growth by the microbial population.

5. A process as defined in any of claims 1-4, wherein the bioreactor is provided in situ, within a natural container, an excavation, impoundment, or a surface-water body; or ex situ in a containment vessel; or ex situ as part of a closed pressurized system.

6. A bioreactor for treating an oxidized contaminant-containing matrix as defined in claim 1, comprising
a. a source of elemental sulfur,
b. microbes comprising a consortium of sulfur-oxidizing, oxidized-contaminant as defined in claim 1 reducing chemolithotrophic microbes, and
c. a support material upon which the microbes can grow.

7. A bioreactor as defined in claim 6, wherein the microbes comprise a microbially populated biofilm with aggregations of the microbes.

8. A bioreactor as defined in claim 7, wherein the support material upon which the microbes can grow comprises elemental sulfur.

9. A bioreactor as defined in claim 8, further including inorganic nutrients and trace materials needed for growth by the microbes.

10. A bioreactor as defined in claim 9, wherein the inorganic nutrients are taken from a group comprising nitrogen, phosphorus, carbon dioxide and trace materials.

11. A bioreactor as defined in claim 10, wherein the microbes are of a type that occur naturally in an oxidized contaminant containing matrix.

12. A bioreactor as defined in claim 10, wherein the microbes are introduced to the bioreactor as an inoculation.

13. A bioreactor as defined in any of claims 6-12, that is formed in situ, within a natural container, excavation, impoundment, or surface-water body; or ex situ in a containment vessel; or ex situ as part of a closed-pressurized system.
